(19) United States
(12) Patent Application Publication
(10) Pub. No.: US 2005/0253360 A1
(43) Pub. Date: Nov. 17, 2005

(54) Pneumatic connector arrangement

(76) Inventor: Duncan Lewis Steyn, Durban (ZA)

Correspondence Address: YOUNG & THOMPSON, 745 SOUTH 23RD STREET, 2ND FLOOR, ARLINGTON, VA, 22202, US

(21) Appl. No.: 10/529,485

(22) PCT Filed: Sep. 26, 2003
(86) PCT No.: PCT/ZA03/00141

§ 371 Date: Mar. 28, 2005

(30) Foreign Application Priority Data
Sep. 26, 2002 (ZA) 2002/7727

(51) Int. Cl. B60D 1/62

(52) U.S. Cl. 280/421

(57) ABSTRACT

A pneumatic connector arrangement for a horse and trailer includes a piston (16) movable within a housing (12) to engage the base of the trailer kingpin (22) which is modified to include discrete passages (40, 42) for conveying permanent air supply and service line air to the trailer pneumatic system. The piston (16) has similar discrete passages (18, 20) which link to the kingpin passages upon link-up of the horse and trailer. The air supplies enter the piston passages by way of ports (30, 32).

### TECHNICAL FIELD OF THE INVENTION

This invention relates to a pneumatic connector arrangement for a horse and trailer.

### BACKGROUND ART

Truck/tractors (also referred to as the “horse”) have compressors, which provide air pressure to drive both it and the trailer's braking system, amongst other applications. Currently, the compressed air is delivered from tractor to trailer, via flexible hoses known as Suzie cables or coils. There are two separate airlines on a rig, one for the permanent supply (to reservoir tanks on both tractor and trailer), and the second, the service line, which is used to activate the brakes.

Suzie cables are vulnerable in a particularly hostile environment. Due to the fact that they are usually fitted to a static position on the rear bulkhead of the tractor cab and then extend to the front of the trailer chassis, which can be a position as much as 2 m forward of the kingpin axis point, it follows that when a rig is turning left or right, these cables can be stretched to a distance of almost 5 m. The cables are “coiled” to give them stretch, whilst keeping them as “short” as possible when required. Constant stretching, uncoiling, fitting and unfitting, snagging on the chassis, being mishandled and being in such a hostile environment result either in broken Suzie coils or constant preventative action, meaning the purchasing of new cables.

Broken or unmatched cables cost the industry millions in lost income. When cables break, they do so whilst the rig is moving, which means they are usually far from workshops and quick assistance. Roadside assistance carries high costs, not only in direct wage/overhead cost, but also in terms of extended downtime for the rig and it's payload.

Suzie cables are also the first line attack in hi-jackings. They are simply cut or stolen, resulting in the rig coming to a halt (if the supply of air is interrupted from tractor to trailer the trailer's brakes are automatically activated) leaving the driver and it's payload in the hands of the perpetrators.

Tractors use a hitching system known as a 5th wheel. Trailers are fitted with a sturdy pin, referred to as a kingpin, which protrudes from it's underside and which engages the “V” of the 5th wheel. When this happens, the 5th wheel automatically locks the kingpin in place, and the connection is thus complete.

It is therefore an object of this invention to provide an alternative pneumatic connection which does not suffer these disadvantages.

### THE INVENTION

According to the invention, a pneumatic connector for a horse and trailer comprises a connector element and a kingpin, the connector element including inlets for permanent air supply and service line air, the connector element including passages for separately conveying the two air supplies to the base of the kingpin, the kingpin including passages for separately conveying the air to outlets for distribution to the trailer pneumatic system, the connector element being movable between a first or disengaged position in which the horse and trailer are unhitched, and a second or engaged position in which the horse and trailer are hitched, the movement of the connector element being initiated by the hitching action.

In the preferred form of the connector, the element comprises a piston movable within a housing. The piston includes vertically spaced apart inlet ports leading to discrete vertical passages within the piston. The housing includes inner connector elements for discretely transferring air from the two inlets to the piston inlet ports. The piston may be pneumatically driven and preferably comprises a double-action piston.

The piston may further include a pair of spaced apart annular grooves defining a channel therearound. The piston inlet ports are preferably located in the grooves and in one form, ten are provided in the upper groove and four in the lower groove.

In the preferred form, two sets of passages are provided in the piston, the first being a single central passage extending from a piston inlet port to the top of the piston and the second set comprising a plurality of passages concentrically arranged about the central passage also exiting the top of the piston. In one form ten passages are arranged about the central one and these convey the permanent air supply with the central passage conveying the service air supply.

The piston preferably comprises an elongate stainless steel element and a ram of greater diameter at the base thereof.

The inner connector elements associated with the piston comprise elongated cylindrical bushes having a central bore in which the piston is slidable and including at the upper and lower ends thereof, flanges defining a channel between them and about the cylindrical bodies of the bushes, the channels including one or more ports extending into the central bore, providing a passage for the air from the inlets to the discrete passages within the piston. A bush locatable between the two elongated cylindrical bushes and a series of O-rings and pneumatic seals locatable between the bushes and the piston and the bushes and the housing, maintain the separation between the air supplies.

The kingpin is preferably dimensioned to conform with the dimensions of existing kingpins.

The base of the kingpin is adapted to engage the top of the piston, with the base of the kingpin including a series of bushes and pneumatic seals to firstly prevent mixing of the air from the two sets of passages and secondly to direct the air exiting the piston into the appropriate passages in the kingpin.

In the preferred form, the kingpin includes a single central passage dimensioned to register with the central passage of the piston, and five concentric passages located therearound, the central passage exiting the kingpin near the top thereof via three horizontally disposed ports and the concentric passages exiting via five similar horizontal ports located a short distance therebelow.

The upper kingpin exit ports connect the service air supply to the service pneumatic system of the trailer with the lower exit ports connecting the permanent air supply to the permanent air system of the trailer.

In one form in which the pneumatic connector arrangement of the invention is fitted as original equipment, the kingpin exit ports engage a banjo coupling which comprises a modified mounting block of the kingpin, for distribution to the trailer pneumatic system.

Where the pneumatic connector is retrofitted to an existing 5th wheel arrangement, a banjo is fitted over the top of the kingpin with the kingpin exit ports being located at the top of the kingpin.

The kingpin preferably comprises high tensile, high sheer strength steel to compensate for structural changes as a result of the passages in the kingpin.

The housing of the pneumatic connector of the invention is divided into upper and lower sections by the piston bushes described above. The lower section includes upper and lower ports to enable air from the horse to drive the piston upwards, upon engagement of the horse and trailer, and downwards upon disengagement. The lower section of the housing is accordingly divided into two compartments by an O-ring or the like pneumatic seal located between the ports.

The O-ring is located between the inner wall of the housing and a sleeve extending from the base of the housing to the top of the lower section, the sleeve includes castellations at the top and bottom thereof to permit passage of air into and out of the compartments.

Passage of air through the housing ports is controlled by a 5/2-way trigger valve. Prior to the link-up of the horse and trailer, the horse supplies air through the upper port. Upon engagement, the trigger valve is mechanically activated to divert air to the lower housing port thereby causing the piston to move from its first or disengaged position to its second or kingpin engaging position Air from the upper compartment is dumped through the upper port.

Upon disengagement of the horse and trailer, the trigger valve is activated to permit air in through the upper port and out through the lower port, the influx or pressurised air causing the piston to move back to the disengaged position, severing air supply to the trailer.

### BRIEF DESCRIPTION OF THE DRAWINGS

FIG. 1 is a sectional view through a pneumatic connector according to the invention;

FIG. 2 is an exploded view of the connector of FIG. 1; FIG. 3 is an enlarged view of FIG. 2;

FIG. 4 is a view of a kingpin;

FIGS. 5a, b and c are sectional views through the kingpin along lines A-A and B-B and C-C respectively;

FIGS. 6 and 7 are sectional views through a piston and housing with the piston in the disengaged and engaged positions respectively;

FIG. 8 is an isometric view of a piston, FIG. 9a is a front view of a piston;

FIG. 9b is a top view of the piston;

FIG. 10 is a sectional view through the base of the kingpin with the piston engaged therewith;

FIG. 11 is an exploded view of the piston bushes; and

FIG. 12 is an exploded view of the kingpin bushes.

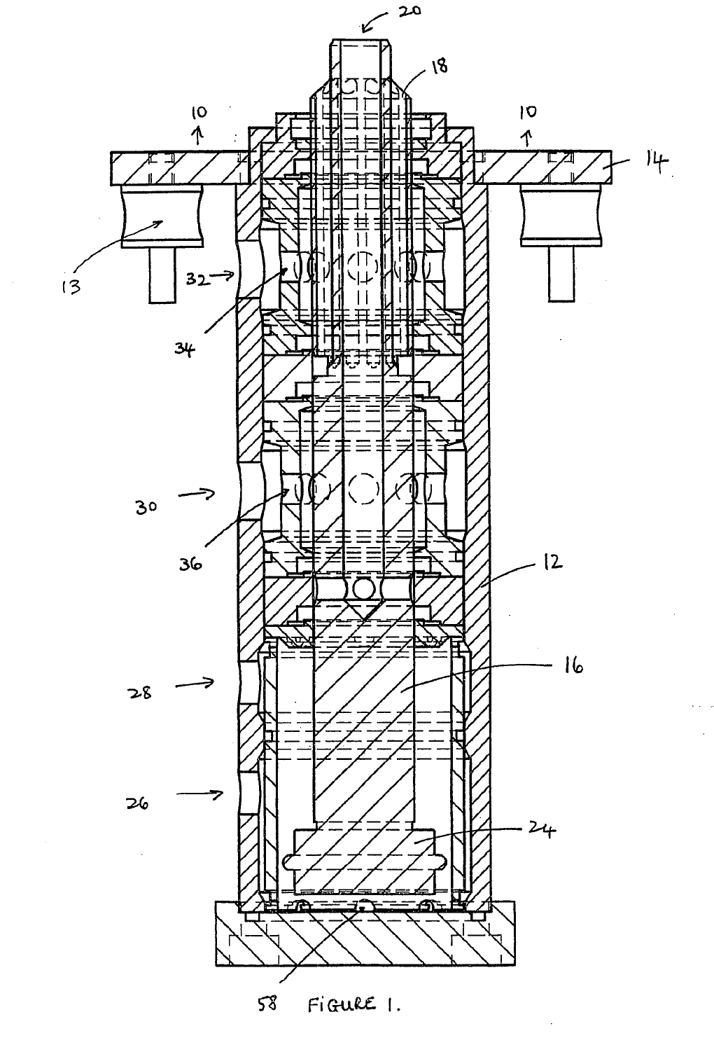

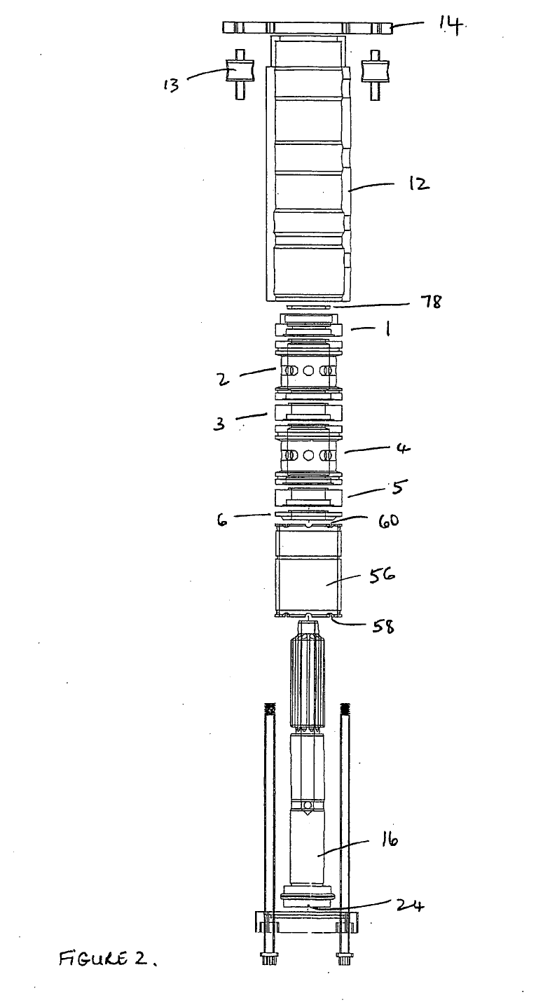

### DESCRIPTION OF THE PREFERRED EMBODIMENT

A pneumatic connector system for a horse and trailer includes conduits for air in the form of pneumatic pipes extending from the truck/tractor's existing permanent and service air supply lines to the pneumatic connector located at the base of the fifth wheel 10.

The pneumatic connector is affixed to the base of the fifth wheel by means of mounting plate 14. Required oscillation is achieved by rubber mounts 13 that are used to connect mounting plate 14 with a bracket structure (not shown) which is attached to the base of the fifth wheel.

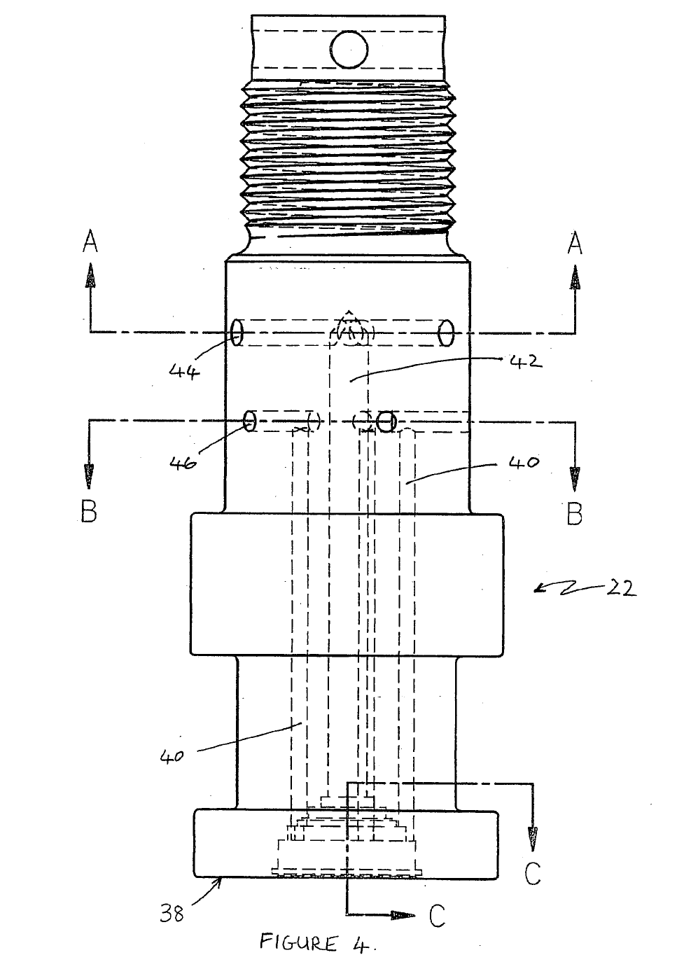

The actual connector comprises a slidable piston 16 having two sets of passages 18 and 20, and an upper stationary kingpin 22 (FIG. 4). Passage 20 carries air for the pneumatic brake activation while passage 18 carries air for the permanent air supply (in the example shown). The kingpin is a modified version of a conventional kingpin, with identical dimensions.

When the trailer is hitched to the fifth wheel of the horse, the engagement of the two activates the piston 16 to spring through the central passage in the fifth wheel to engage the kingpin. A locking mechanism clamps the kingpin to complete the coupling while the position of the piston is maintained by the pressure exerted from below by the piston ram 24 which is in turn under air pressure via port 26.

The top of the piston 16 is profiled/shaped to engage the machined base 38 of the kingpin 22 including bushes 84 and 86. The pressurised air enters port 26 upon physical engagement of the horse and trailer. This first trigger does not immediately complete the pneumatic link-up but is the first in a series of sequential steps initiated by the physical engagement, to complete the pneumatic link up. The housing 12 remains stationery.

When the piston ram is forced upwards, movement of the piston 16 causes the air supplied at inlets 32 and 30 to become connected to passages 18 and 20 via ports 34 and 36. Permanent air supply enters via the port 34 while break activation (service) air supply enters via the port 36. The two air supplies travel separately and unmixed through passages 18 and 20 in the piston 16. At the top of the piston 16, there is an engagement with the lower end 38 of the kingpin 22. Pneumatic seals 88 and 90 housed within bushes 84 and 86 prevent mixing of the two air supplies.

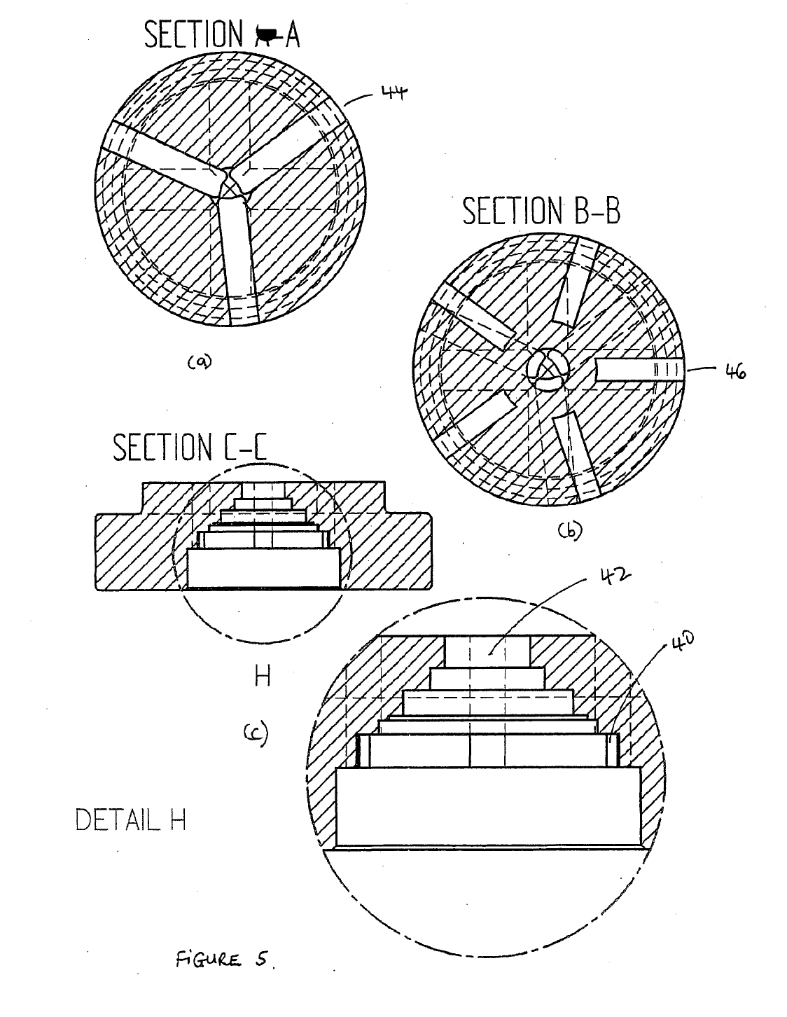

Air travels through passages 40 and 42 in the kingpin 22 and exits at a banjo (not shown) with break activation air exiting via ports 44 and permanent air supply via ports 46. (see FIGS. 4 and 5)

The air supplies are then distributed in pneumatic pipes to their appropriate points in the trailer.

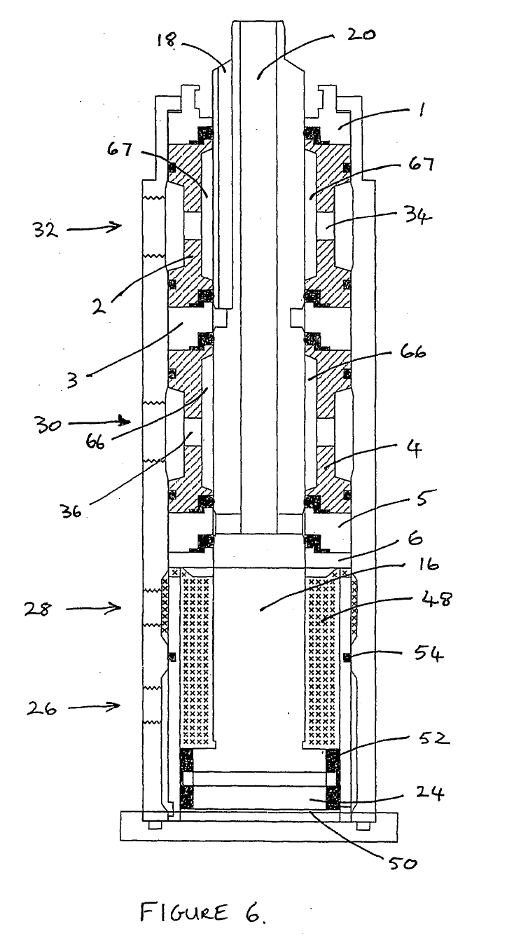

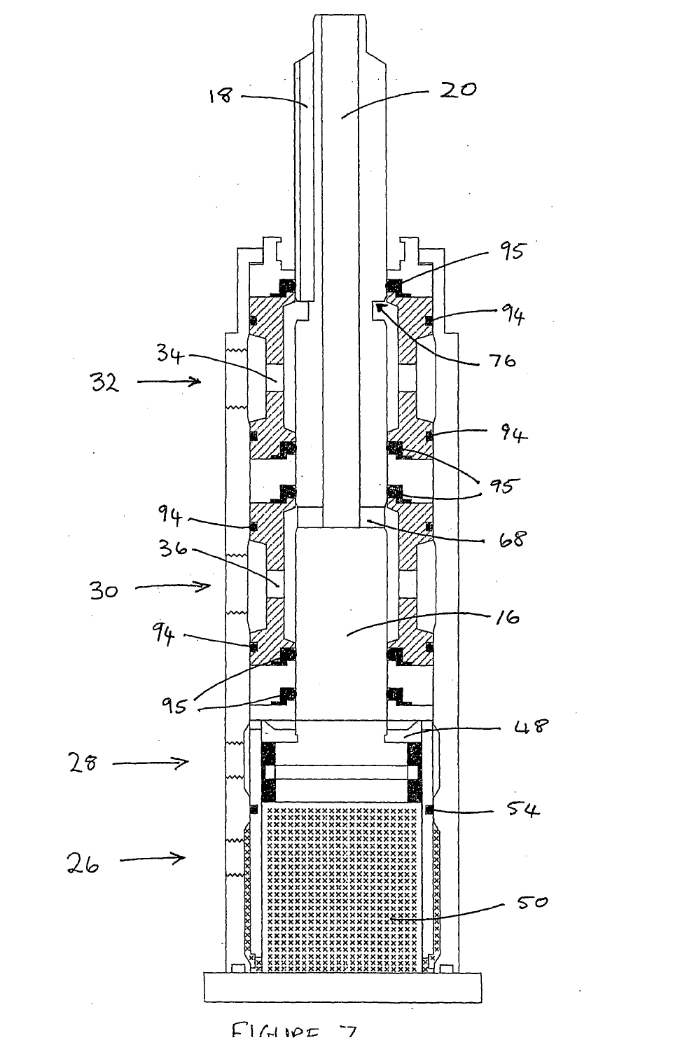

Turning now to FIGS. 6 and 7, the horse supplies air to ports 26 and 28 in the housing 12 via a 5/2-way trigger valve which either starts the sequential engagement process or initiates the start of sequential disengagement. When the trailer is not linked to the fifth wheel, the situation in FIG. 6 applies. Air enters port 28 and fills the compartment 48 with pressurised air, retaining the piston ram 24 and hence the piston 16 in its collapsed (disengaged) position at the lower end of the housing. Air is prevented from reaching compartment 50 by seal 52 and O-ring 54.

When the trailer links up to the fifth wheel, the 5/2-way trigger valve is activated to divert air in through port 26, and cause air in compartment 48 to dump through port 28. The air entering through port 26 forces the ram 24 upwards to the position in FIG. 7. It is in this position that piston 16 engages the base 38 of the kingpin 22 and links the air supply from the horse to the trailer. The constant pressure of air in compartment 50 maintains it in constant contact with the base 38 of the kingpin 22.

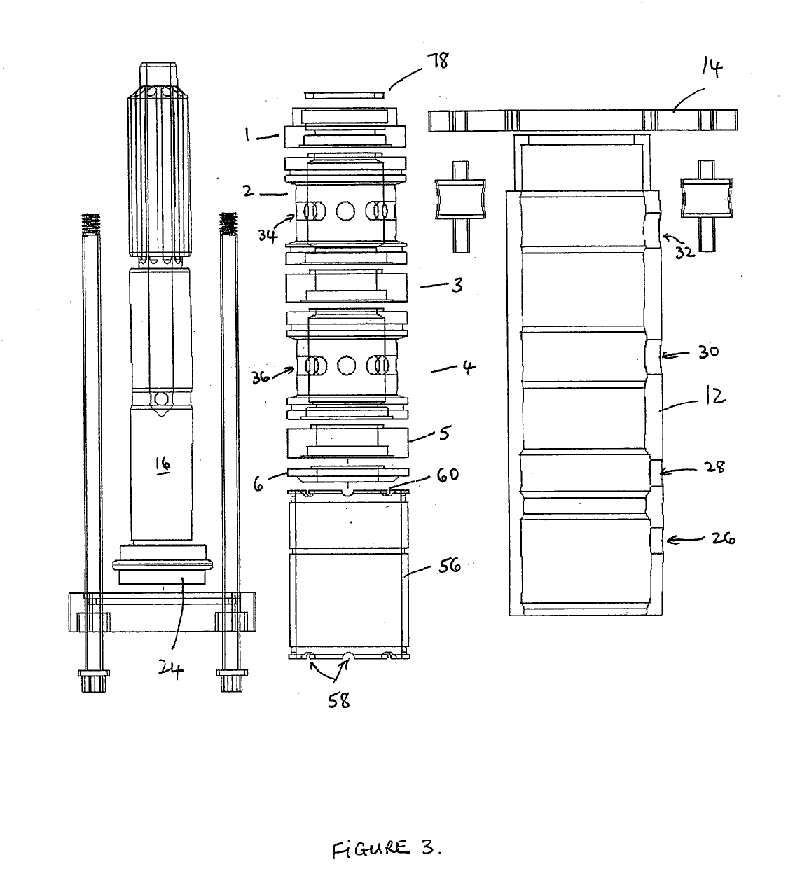

This lower section of the housing 12 includes a sleeve 56 which fits within the housing and permits the piston and ram to slide vertically therein. The sleeve has castellations 58 at the bottom end thereof to permit passage of air between port 26 and compartment 50 below the ram, and castellations 60 above compartment 48 to permit passage of air between port 28 and compartment 48 (see FIGS. 2 and 3).

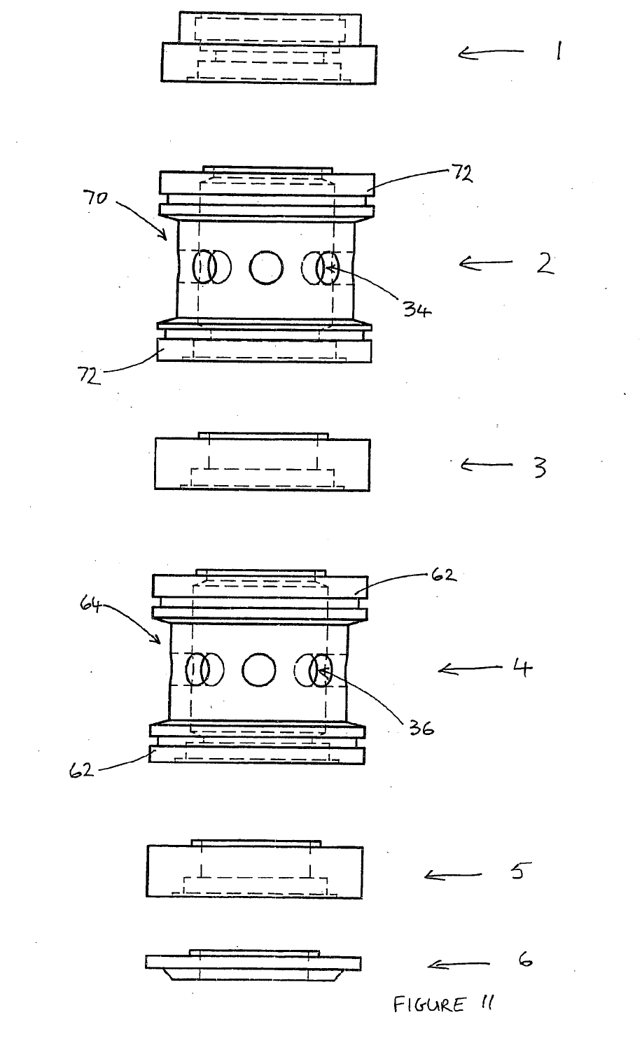

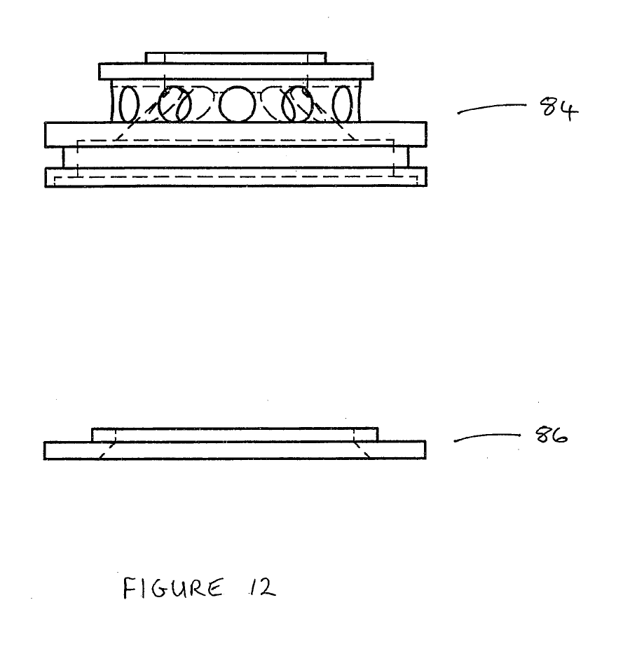

In the upper section of the housing above the sleeve 56, there is provided a series of six piston bushes which permit sliding of the piston 16 to activate and deactivate air supply from inlets 32 and 30 to passages 18 and 20 and also to ensure that these air supplies are not mixed within the housing of the connector. These bushes are shown in detail in FIG. 11

At the base of the upper section and sitting directly atop the sleeve 56, is piston bush 6, and then piston bush 5. Piston bush 4 sits thereabove and comprises an elongate cylindrical element including peripheral flanges 62 at the top and bottom defining a channel 64 about the cylinder. The cylinder has multiple ports 36 opening into the centre of the cylinder, permitting passage of air from inlet 30 (service line) into the void 66 surrounding the piston 16. When the piston 16 is in the extended or engaged position of FIG. 7, the air is able to enter the central passage 20 of the piston via peripheral piston ports 68.

A further piston bush 3 is located atop piston bush 4 and then piston bush 2 sits atop piston bush 3. Piston bush 2 is similar in construction to piston bush 4 in that it also has a channel 70 between upper and lower flanges 72 with multiple ports 34. This time this channel permits entry of air from inlet 32 permanent air supply) via peripheral ports 76 in the piston 16 to passages 18, for conveyance to the kingpin, when the piston is in the engaged position of FIG. 7.

It is important to note the proximity of ports 68 and 76 of the piston to the lowers ends of piston bush 4 and piston bush 2 respectively, as well as the height of the voids 66 and 67 which firstly ensures instantaneous access to air when the trailer is linked up, and secondly, substantial vertical movement to accommodate for vertical movements of the kingpin 22 and piston 16 and thereby ensure constant air supply. In addition, various O-ring 94 and pneumatic spool seals 95 prevent the two air supplies from mixing.

Piston bushes 2 and 1 sit atop piston bush 3, while a thrust bush 78 sits in piston bush 1 as does a wiper seal. The thrust bush is brass and is the wearing part that contacts the piston 16.

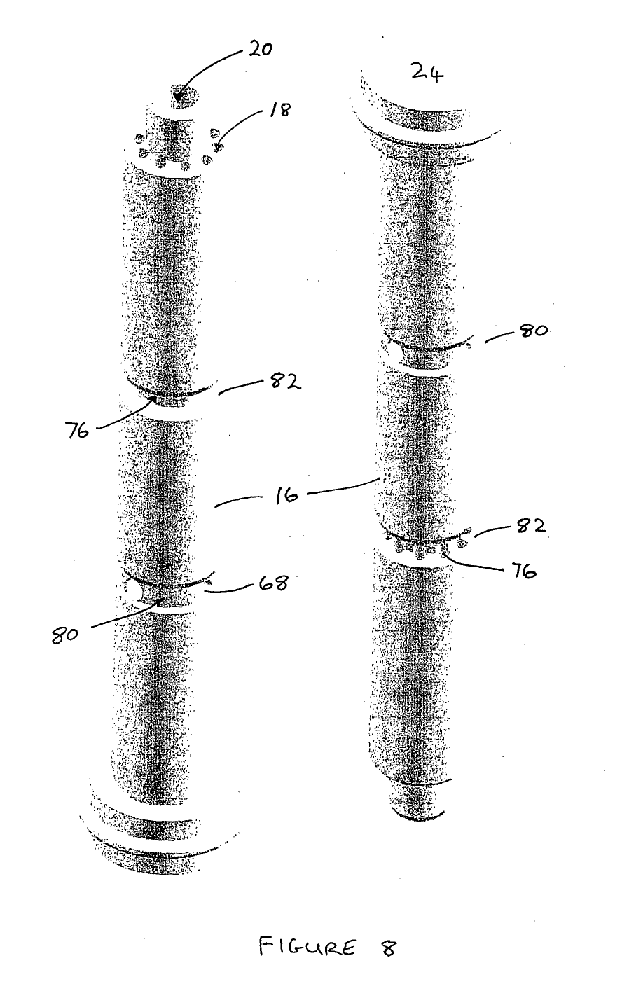

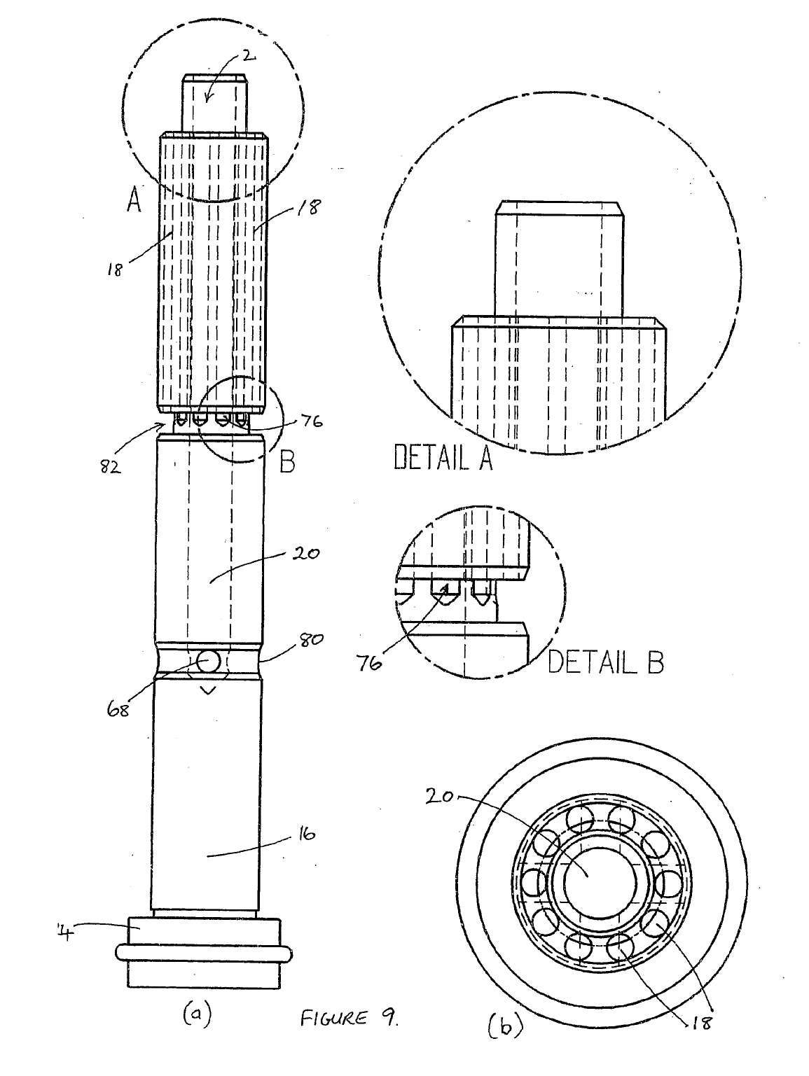

In FIGS. 8 and 9, the piston 16 is shown in more detail to comprise an elongate stainless steel element having a ram 24 at the base with a diameter wider than that of the body of the piston. The piston includes a pair of spaced apart annular grooves 80 and 82 defining a channel therearound. Piston ports 68 and 76 are located in these grooves. The piston includes a set of passages 18 and a central passage 20. Central passage 20 carries the service line air while concentric passages 18 convey the permanent air supply.

In FIG. 5, the detail of the kingpin is shown in sectional view. The kingpin has a central passage 42 for conveying service line air and five concentric passages 40 for conveying permanent air supply air. These passages exit via three horizontal ports 44 and five horizontal ports 46.

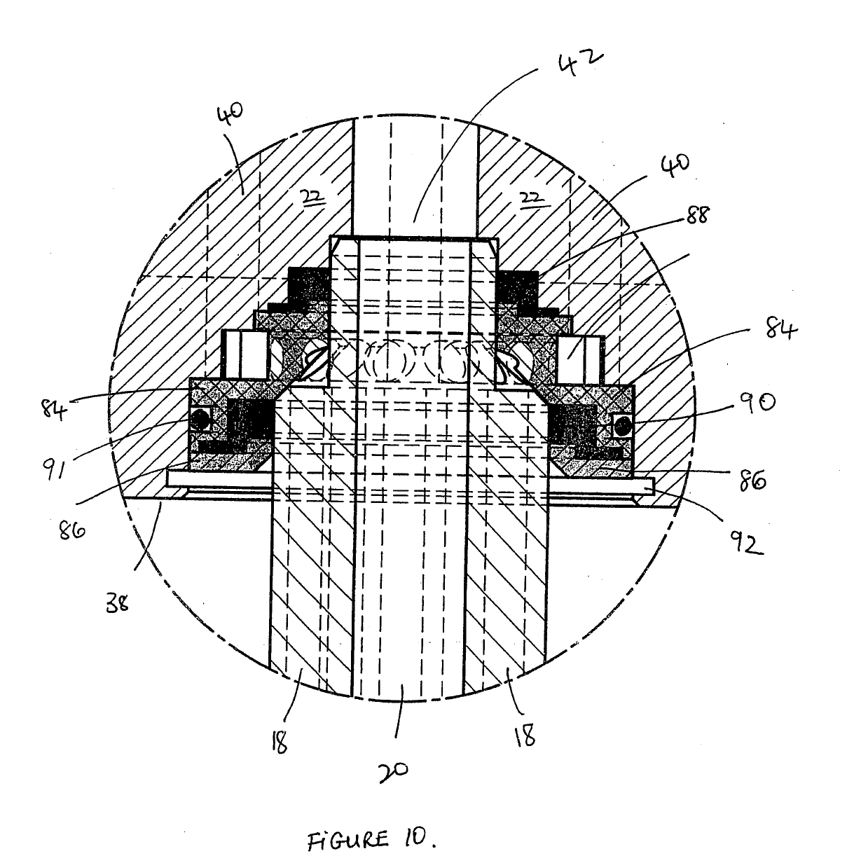

In FIG. 10, the engagement between the piston 16 and the base 38 of the kingpin 22 is shown. The kingpin is provided with a pair of bushes 84 and 86 which together with pneumatic seals 88 and 90 and O-ring 91 ensure that the air from passages 18 and 20 enters passages 40 and 42 respectively, and separately. A circlip in groove 92 holds the bushes in place.

1-23. (canceled)

24. A pneumatic connector for a horse and trailer comprises a piston and a kingpin, the piston being slidable in a housing, the housing including inlets for permanent air supply and service line air, the piston including passages for separately conveying the two air supplies to the base of the kingpin, the kingpin including passages for separately conveying the air to outlets for distribution to the trailer pneumatic system, the piston being, slidable between a first or disengaged position and a second or kingpin-engaging position upon hitching or unhitching of the horse and trailer, characterised in that upon hitching of the horse and trailer, the piston is adapted to re-direct ai flow from the inlets, through the passages in the body of the piston and into the kingpin upon movement of the piston into the kingpin-engaging position.

25. A pneumatic connector according to claim 24 characterised in that the piston includes vertically spaced apart circumferential inlet ports leading to discrete vertical passages within the piston.

26. A pneumatic connector according to claim 24 characterised in that the piston further includes a pair of spaced apart annular grooves defining a channel therearound, in which the piston inlet ports are located.

27. A pneumatic connector according to claim 24 characterised in that a plurality of inlet ports are provided for each air supply.

28. A pneumatic connector according to claim 27 characterised in that ten ports are provided in the upper groove and four in the lower groove.

29. A pneumatic connector according to claim 25 characterised in that two sets of passages are provided in the piston, the first being a single central passage extending from a piston inlet port to the top of the piston and the second set comprising a plurality of passages concentrically arranged about the central passage also exiting the top of the piston.

30. A pneumatic connector according to claim 29 characterised in that ten passages are arranged about the central passage.

31. A pneumatic connector according to claim 29 characterised in that the concentric passages convey the permanent air supply with the central passage conveying the service air supply.

32. A pneumatic connector according to claim 24 characterised in that the piston comprises an elongate stainless steel element and a ram of greater diameter at the base thereof.

33. A pneumatic connector according to claim 24 characterised in that the housing includes inner connector elements for discretely transferring air from the two inlets to the piston inlet ports, the inner connector elements comprising elongated cylindrical bushes having a central bore in which the piston is slidable, and including at the upper and lower ends thereof, flanges defining a channel between them and about the cylindrical bodies of the bushes, the channels including one or more ports extending into the central bore, providing a passage for the air from the inlets to the discrete passages within the piston.

34. A pneumatic connector according to claim 33 characterised in that the separation between the air supplies is maintained by a bush locatable between the two elongated cylindrical bushes and a series of O-rings and pneumatic seals locatable between the bushes and the piston, and the bushes and the housing.

35. A pneumatic connector according to claim 24 characterised in that the kingpin is dimensioned to conform with the dimensions of existing kingpins to permit retro-fitting to existing fifth wheel arrangements.

36. A pneumatic connector according to claim 24 characterised in that the kingpin includes a single central passage dimensioned to register with the central passage of the piston, and five concentric passages located therearound, the central passage exiting the kingpin near the top thereof via three horizontally disposed ports and the concentric passages exiting via five similar horizontal ports located a short distance therebelow.

37. A pneumatic connector according to claim 24 characterised in that the kingpin includes five concentric passages exiting via five horizontal ports.

38. A pneumatic connector according to claim 36 characterised in that the upper kingpin exit ports connect the service air supply to the service pneumatic system of the trailer with the lower exit ports connecting the permanent air supply to the permanent air system of the trailer.

39. A pneumatic connector according to claim 36 fitted as original equipment characterised in that the kingpin exit ports engage a banjo coupling which comprises a modified mounting block of the kingpin, for distribution to the trailer pneumatic system.

40. A pneumatic connector according to claim 36 retro-fitted to an existing 5th wheel arrangement characterised in that a banjo is fitted over the top of the kingpin with the kingpin exit ports being located at the top of the kingpin.

41. A pneumatic connector according to claim 24 characterised in that the kingpin comprises high tensile, high sheer strength steel.

42. A pneumatic connector according to claim 33 characterised in that the housing is divided into upper and lower sections by the piston bushes, seals and O-rings, the lower section including upper and lower ports to enable air from the horse to drive the sliding-valve connector upwards, upon engagement of the horse and trailer, and downwards upon disengagement, the lower section of the housing is being divided into two compartments by an O-ring or the like pneumatic seal located between the ports.

43. A pneumatic connector according to claim 42 characterised in that the O-ring is located between the inner wall of the housing and a sleeve extending from the base of the housing to the top of the lower section, the sleeve including castellations at the top and bottom thereof to permit passage of air into and out of the compartments.

44. A pneumatic connector according to claim 42 characterised in that the passage of air through the housing ports is controlled by a 5/2-way trigger valve.
